(19) United States
(12) Patent Application Publication
(10) Pub. No.: US 2016/0181701 A1
(43) Pub. Date: Jun. 23, 2016

(54) ANTENNA HAVING A REFLECTOR FOR IMPROVED EFFICIENCY, GAIN, AND DIRECTIVITY

(71) Applicants: Pragash Sangaran, Oakland, CA (US); Ken Margon, Oakland, CA (US)

(72) Inventors: Pragash Sangaran, Oakland, CA (US); Ken Margon, Oakland, CA (US)

(21) Appl. No.: 14/860,682

(22) Filed: Sep. 21, 2015

Related U.S. Application Data
(60) Provisional application No. 62/052,810, filed on Sep. 19, 2014.

(51) Int. Cl. H01Q 15/14; H01Q 9/04

(52) U.S. Cl. CPC H01Q 15/14; H01Q 9/04

(57) ABSTRACT

An antenna having at least one reflector for improving radiation efficiency, gain, and directivity is disclosed. The antenna may be formed on a substrate or be a standalone conductive material that is designed to operate in at least one band of frequency. The antenna includes a reflector for each band of frequency the antenna is designed to operate in. The reflector is positioned relative to the antenna to redirect electromagnetic radiation of the antenna away from surrounding materials or objects that affect, i.e., reflect, refract, diffract, absorb and scatter the antenna's electromagnetic radiation.

### CROSS-REFERENCE TO RELATED APPLICATION

The present application claims priority to U.S. Provisional Patent Application No. 62/052,810, filed on Sep. 19, 2014, entitled “Antenna Miniaturization Technique with Reflector” the entire disclosure of which is incorporated by reference herein.

### BACKGROUND OF THE INVENTION

1. Field of Invention

This invention relates generally to antenna designs for communication devices and more specifically, to an improved antenna design for communication devices with increased radiation efficiency.

2. Description of Related Art

Wireless communication devices, such as smartphones, laptop computers, tablet computers, access points, health monitoring devices, etc. all make use of multiple antenna types to establish wireless connections between one or more devices. With the advancements being made in wireless technologies, the demand on antennas used in these wireless devices has increasingly called for greater area and volume requirements. Unfortunately, today's users of wireless communication devices want smaller handheld and portable devices. Thus, the actual size of the antenna within today's handheld and portable devices is of great importance when considering antenna design.

In addition to considering the size of the antenna, current technology, such as 3G, LTE and Wi-Fi, require implementation of multi-band frequencies. For dual-band and tri-band technologies, planar inverted F-antenna (PIFA) is most preferred due to its low profile, which is easily designable and implementable. One limitation in using PIFAs, however, is the ground clearance needed underneath the antenna. Therefore, any component or printed circuit board (PCB) that lies in parallel to a PIFA will act as a ground extension reducing PIFA radiation efficiency, peak gain, and directivity by half or more.

Generally, an antenna's performance can be characterized in terms of the antenna radiation efficiency and gain. An antenna's radiation efficiency is a measure of the electromagnetic energy radiating from the antenna that is transformed from the power fed to the terminals of the antenna. An antenna's gain is essentially the ability of the antenna to direct the electromagnetic energy in a particular direction. In today's wireless communication devices, losses in antenna radiation efficiency and gain are inevitable due to electronic components and materials that surround the antenna of the wireless communication device. These components and materials absorb some of the radiating energy converting it to heat energy and ultimately lowering the efficiency and gain of the devices antenna.

Therefore, there exists a need for an antenna design that improves upon a wireless communication devices antenna efficiency, gain, and directivity.

### SUMMARY OF THE INVENTION

The present invention overcomes these and other deficiencies of the prior art by providing an antenna with increased radiation efficiency. One embodiment of the present invention comprises an antenna that is designed to operate in at least one band of frequency, wherein the antenna is formed on a substrate. A reflector is included for each band of frequency the antenna is designed to operate in and is positioned relative to the antenna to redirect electromagnetic radiation of the antenna away from being affected or absorbed by surrounding materials or objects.

In another embodiment of the present invention, a wireless communications device comprises a transceiver having an antenna to transmit or receive electromagnetic radiation. The antenna of the wireless communications device comprises an antenna designed to operate in at least one band of frequency, wherein the antenna is formed on a substrate. A reflector is included for each band of frequency the antenna is designed to operate in and is positioned relative to the antenna to redirect electromagnetic radiation of the antenna away from being affected or absorbed by surrounding materials or objects.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1A illustrates a top view of a PIFA with a parallel reflector according to an embodiment of the invention;

FIG. 1B illustrates a bottom view of a PIFA with a parallel reflector for a low band and a high band according to another embodiment of the invention;

FIG. 2A illustrates graphically the radiation efficiency of a dual band PIFA with a single and dual reflector at a low frequency band (i.e. GSM 850) according to another embodiment of the invention;

FIG. 2B illustrates graphically the radiation efficiency of a dual band PIFA with a single and dual reflector at a high frequency band (i.e. GSM 1900) according to another embodiment of the invention; and

FIG. 3A illustrates graphically the peak gain of a dual band PIFA with a single and dual reflector at a low frequency band (i.e. GSM 850) according to another embodiment of the invention;

FIG. 3B illustrates graphically the peak gain of a dual band PIFA with a single and dual reflector at a high frequency band (i.e. GSM 1900) according to another embodiment of the invention.

### DETAILED DESCRIPTION OF PREFERRED EMBODIMENTS

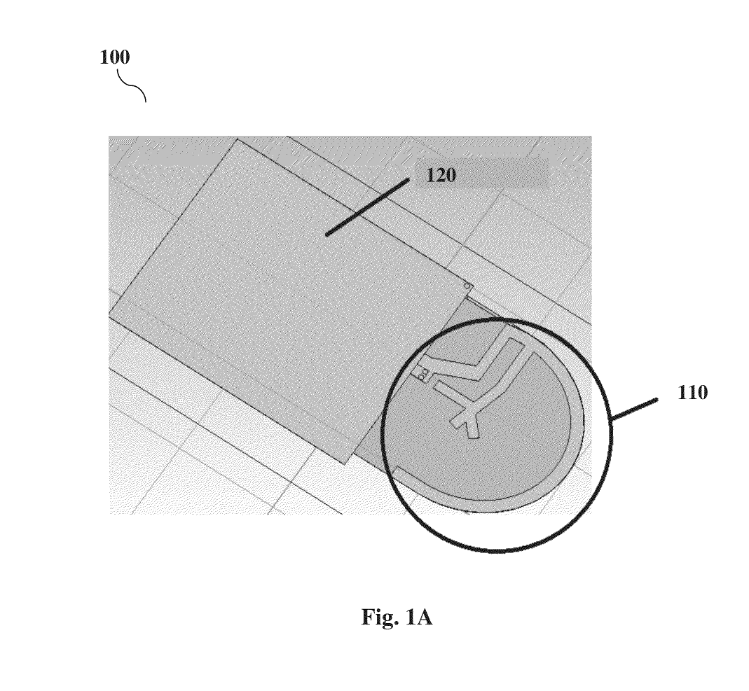

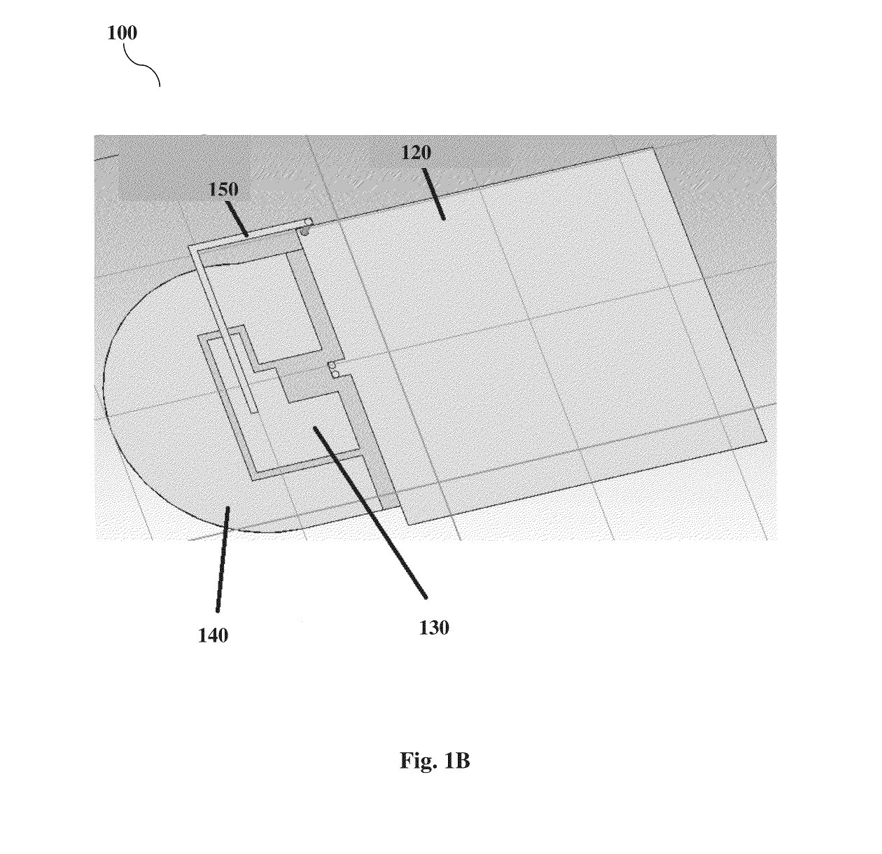

Preferred embodiments of the present invention and their advantages may be understood by referring to FIGS. 1-3, wherein like reference numerals refer to like elements. Although the present invention is described and illustrated in the context of a PIFA, it is to be understood that the disclosure of the present invention is not limited to a PIFA but is equally applicable to antennas in general, including by way of non-limiting examples, monopole antenna, dipole antenna, folded dipole antenna, loop antenna, slot antenna, cavity-backed slot antenna, inverted-F antenna, slotted waveguide antenna, helical antenna, spiral antenna, short dipole antenna, half-wave dipole antenna, broadband dipole antenna, rectangular patch antenna, patch antenna, folded inverted-F antenna, and any of the PCB or smaller size antennas. In some embodiments, the antenna may be designed on other materials other than PCB such as ceramics, single conductor without substrate and the like. The antenna may be designed as a standalone conductive element made of any conductive material known to those of ordinary skill in the art.

As used in wireless communication devices, the antennas of the present invention are capable of single band to multiple band operation. The wireless communication devices include a transceiver to transmit and receive electromagnetic radiation. The wireless communication devices may be mobile phones, smartphones, laptop computers, tablet computers, desktop computers, access points, health monitoring devices, as well as devices incorporating wireless communication technologies including, but not limited to, Bluetooth, Zigbee, 3G, Wi-Fi, GPS, satellite, microwave, and the like. The wireless communication devices may also include a single antenna or multiple antennas and may be any combination of antenna types as described above. As such, the reflector may be a single reflector or may be multiple reflectors depending upon the antenna design of the wireless communication device. Likewise, the number of reflectors may depend upon whether the antenna is a single band antenna or multi-band antenna. The reflectors of the present invention may be connected to one another in an embodiment wherein multiple reflectors are required because the wireless communications device comprises multi-band antennas. In other embodiments, the reflectors of the present invention are not connected to one another but are separate from one another in an embodiment wherein multiple reflectors are required because the wireless communications device comprises multi-band antennas.

The reflector of the present invention may be comprised of any conductive material including, but not limited to, silver, copper, gold, aluminum, zinc, and the like. The reflector of the present invention is designed and implemented in wireless communication devices to redirect electromagnetic radiation (EM) from the antenna(s) of the wireless communication device. The reflector redirects the EM radiation away from components, ground planes, or any other surrounding materials or objects that may absorb the antennas EM radiation thereby affecting antenna radiation efficiency, gain, and directivity. The components, ground planes, or any other surrounding materials or objects may include, but is not limited to, the human body, circuits, ground extensions, ground planes, speakers, microphones, any component that may be mounted on a printed circuit board (PCB), or any object known to those of ordinary skill in the art that is capable of affecting/absorbing EM radiation.

The reflector of the present invention may be formed on any substrate known to those of skill in the art or may be a standalone conductive sheet comprised of any conductive material as described above. The reflector, if formed on a substrate, may be on a flex PCB, rigid PCB, kapton PCB, or the like. The reflector may form a part of the wireless communication device or may be detachably affixed to the wireless communication device. In some embodiments, the reflector may be a pure standalone conductive element without being formed on a substrate.

Because the reflector of the present invention redirects EM radiation away from materials or objects that affect (i.e., reflect, refract, diffract, absorb and scatter) EM radiation, the reflector is preferably placed between the antenna(s) of the wireless communication device and the materials or objects that affect (i.e., reflect, refract, diffract, absorb and scatter) EM radiation. The reflector is optimally placed in an area of the wireless communication device based on the antenna's radiation pattern and where most of the EM radiation of the antenna is directed. Placement of the reflector in the wireless communication device does not follow a specific rule or formula but is dependent upon positioning to optimize and maximize radiation efficiency, gain, and directivity. Accordingly, the distance from the reflector to the antenna of the wireless communication device may vary. The optimal distance may be determined by measuring or simulating the radiation efficiency/gain at various distances using techniques known to those of ordinary skill in the art until maximum radiation efficiency/gain is achieved. Once the optimal location of the reflector is determined, the antenna may be optimized by varying the arm lengths of the antenna, which will depend upon the antenna frequency band of operation, size constraints of the wireless communication device, etc. Antenna input impedance/feed line impedance changes when a reflector is applied in parallel and vertically and also when changing the distance of the reflector from the antenna. Optimization of the antenna is required to achieve maximum antenna performance after placement of the reflector in the wireless communication device. Because the location of materials or objects that affect EM radiation is known, in some embodiments, the antenna may be optimally designed ahead of time with reflector in position therefore eliminating optimization of the antenna after placement of the reflector.

FIG. 1A illustrates a top view of a PIFA with a parallel reflector according to an embodiment of the invention. The PIFA antenna 100 includes a dual band PIFA 110 connected in series with a PCB ground plane 120. The PCB antenna may be implemented on a flex PCB which contains ER4 substrate and copper or any PCB and substrate as described herein above. The PCB ground plane 120 may be the main board ground plane or may be in the middle of a multilayer PCB board.

FIG. 1B illustrates a bottom view of a PIFA with a reflector for a low band and a high band according to this embodiment of the invention. The PIFA antenna 100 includes a high band parasitic reflector 130 and a low band parasitic reflector 140. The distance between the low band and the high band reflector can be any distance and will depend on the factors discussed above such as size constraints of the wireless communication device. The reflectors 130 and 140 may be made of any suitable conductive material known to those of ordinary skill the art, and in this embodiment is not connected to any PCB ground point. A PCB ground extension 150 is located underneath the PIFA 110 (not shown—see FIG. 1A). The PCB ground extension 150 is a ground extension of the PCB ground plane 120. The PCB ground extension 150 may also represent any component, material, or object that affects/absorbs EM radiation. Those of ordinary skill in the art will likewise recognize that the bottom of the PCB of the present embodiment will include circuits, components, and the like (not shown) that affect/absorb EM radiation.

As discussed above, the reflectors of the present invention may be a single reflector or multiple reflectors within a wireless communication device. For example, if a wireless communication device includes three single band antennas, then for optimum performance, the wireless communication device in this example would need three reflectors —one for each single band antenna. Moreover, dual band antennas require two different, separate reflectors for maximum performance; tri-band antennas require three different, separate reflectors; and so on. For example, a wireless communication device with one dual band antenna and one tri-band antenna would require five different, separate reflectors—two for the dual band antenna and three for the tri-band antenna. The distance between each reflector in a wireless communication device can be optimized for the best performance of radiation efficiency, peak gain and directivity as discussed above. Likewise, in some embodiments, the reflectors are connected to one another, and in other embodiments, the reflectors are separated from one another.

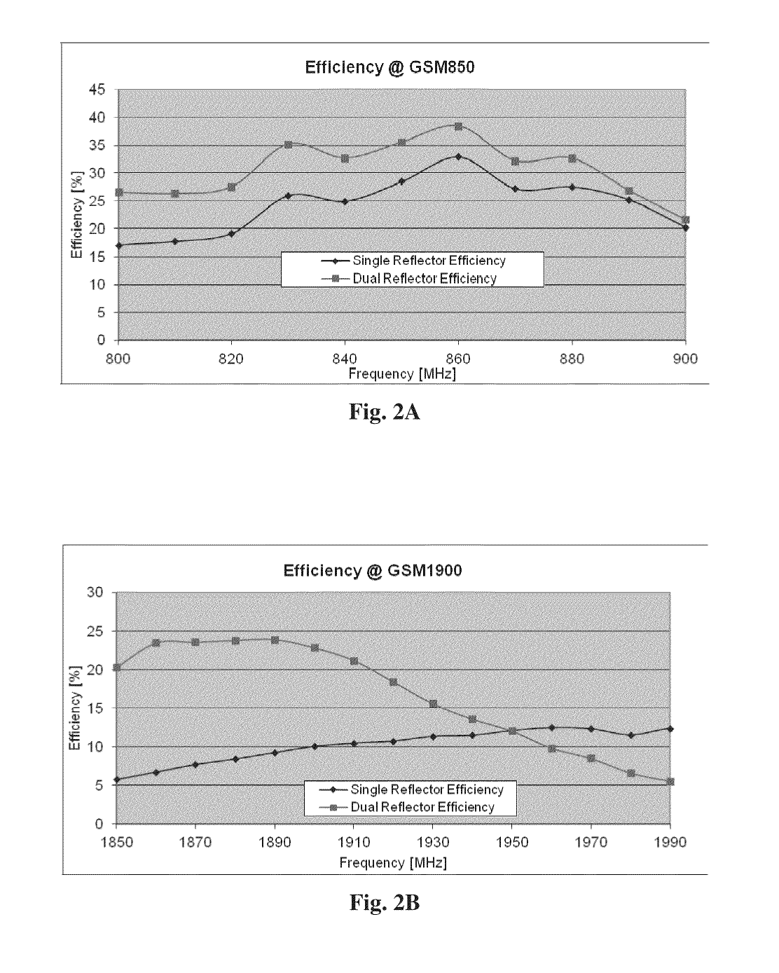

FIGS. 2A and 2B illustrate graphically the radiation efficiency of a dual band PIFA with a single and dual reflector at a low frequency band (FIG. 2A) and a high frequency band (FIG. 2B) according to an embodiment of the invention. A simulated radiation efficiency measurement was obtained using an industry standard simulation tool. The simulated radiation efficiency measurement shows radiation efficiency of a dual band PIFA with a single reflector and dual reflector as in FIG. 1B. To obtain the measurements for the dual reflector, a separate reflector was used for each arm of the PIFA. The separation distance as represented in this simulation is 1mm As can be seen, there is huge advantage in radiation efficiency and bandwidth when using a dual reflector versus a single reflector.

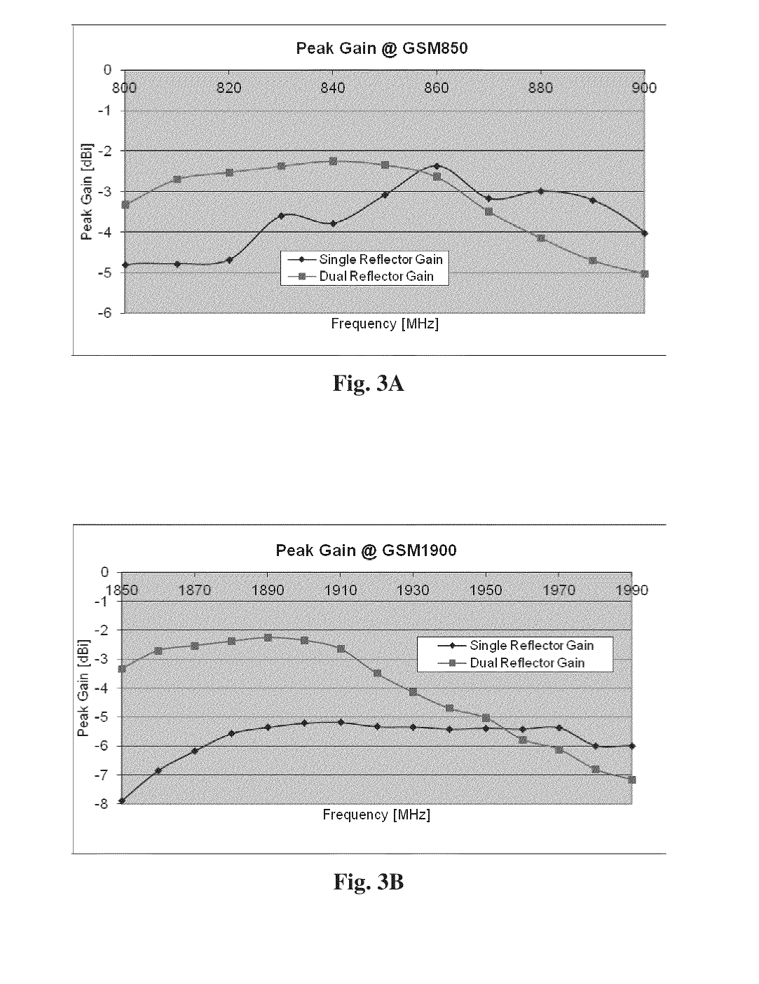

FIGS. 3A and 3B illustrates graphically the peak gain of a dual band PIFA with a single and dual reflector at a low frequency band (FIG. 3A) and a high frequency band (FIG. 3B) according to an embodiment of the invention. A simulated peak gain measurement was obtained using an industry standard simulation tool. FIG. 3A shows peak gain of a PIFA antenna taking measurements while using a single reflector versus a dual reflector at GSM850 (low band). FIG. 3B shows peak gain of a PIFA antenna taking measurements while using a single reflector versus a dual reflector at GSM1900 (high band). As can be seen, peak gain and directivity also improve when using a dual reflector versus a single reflector.

The size and shape of the reflector is optimizable and does not follow any rule or specific guideline. Optimization can be done manually or using computer aided design (CAD) simulation tools. Generally the size of the reflector needs to be bigger than the antenna in order for it to reflect the radiation lobes of the antenna.

In terms of product certification, over the air (OTA) performance and specific absorption rate (SAR) will also improve with the reflector of the present invention. OTA performance improves due to increased radiation efficiency and improved SAR due to the directivity and peak gain being redirected away from the human body.

The reflector of the present invention may be placed in parallel, vertical or in both directions depending upon location of the components, material, or objects that affect/absorb EM radiation.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Moreover, the described features, structures, or characteristics of the invention may be combined in any suitable manner in one or more embodiments. It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents. Reference will now be made in detail to the preferred embodiments of the invention.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims. U.S.

We claim:

1. An antenna with increased radiation efficiency, gain, and directivity, comprising:
an antenna designed to operate in at least one band of frequency, wherein the antenna is formed on a substrate; and
a reflector for each band of frequency the antenna is designed to operate in;
wherein the reflector is positioned relative to the antenna to redirect electromagnetic radiation of the antenna away from being affected or absorbed by surrounding materials or objects.

2. The antenna of claim 1, wherein the antenna is designed as a standalone conductive material.

3. The antenna of claim 1, wherein the reflector is a standalone conductive element.

4. The antenna of claim 1, wherein the reflector for each band of frequency the antenna is designed to operate in is connected to one another.

5. The antenna of claim 1, wherein the reflector for each band of frequency the antenna is designed to operate in is separate from one another.

6. The antenna of claim 1, wherein the antenna is selected from the group consisting of a monopole antenna, dipole antenna, folded dipole antenna, loop antenna, slot antenna, cavity-backed slot antenna, inverted-F antenna, slotted waveguide antenna, helical antenna, spiral antenna, short dipole antenna, half-wave dipole antenna, broadband dipole antenna, rectangular patch antenna, patch antenna, and folded inverted-F antenna.

7. The antenna of claim 1, wherein the antenna is a planar inverted-F antenna.

8. The antenna of claim 1, wherein the antenna forms a part of a wireless communications device.

9. The antenna of claim 8, wherein the wireless communications device is a mobile phone, a smartphone, a laptop computer, a tablet computer, a desktop computer, an access point, or a health monitoring device.

10. The antenna of claim 9, wherein the wireless communications device has a plurality of antennas.

11. The antenna of claim 1, wherein the surrounding materials or objects are ground planes, circuits, ground extensions, speakers, microphones, or any component mounted on a printed circuit board.

12. The antenna of claim 1, wherein the reflector is formed on a substrate.

13. The antenna of claim 12, wherein the substrate is selected from the group consisting of flex printed circuit board, rigid printed circuit board, or Kapton printed circuit board.

14. The antenna of claim 1, wherein the reflector is positioned based on the antenna's radiation pattern and where most of the antenna's electromagnetic radiation is directed.

15. The antenna of claim 14, wherein the antenna is optimized to achieve maximum antenna performance after the reflector is positioned.

16. The antenna of claim 1, wherein the reflector is in parallel with the antenna.

17. The antenna of claim 1, wherein the reflector is vertically disposed with respect to the antenna.

18. A wireless communications device, comprising:
a transceiver having an antenna to transmit or receive electromagnetic radiation, the antenna comprising:
an antenna designed to operate in at least one band of frequency, wherein the antenna is formed on a substrate; and
a reflector for each band of frequency the antenna is designed to operate in;
wherein the reflector is positioned relative to the antenna to redirect electromagnetic radiation of the antenna away from being affected or absorbed by surrounding materials or objects.

19. The wireless communications device of claim 18, wherein the antenna is designed as a standalone conductive material.

20. The wireless communications device of claim 18, wherein the reflector is a standalone conductive element.

21. The wireless communications device of claim 18, wherein the reflector for each band of frequency the antenna is designed to operate in is connected to one another.

22. The wireless communications device of claim 18, wherein the reflector for each band of frequency the antenna is designed to operate in is separate from one another.

23. The wireless communications device of claim 18, wherein the antenna is selected from the group consisting of a monopole antenna, dipole antenna, folded dipole antenna, loop antenna, slot antenna, cavity-backed slot antenna, inverted-F antenna, slotted waveguide antenna, helical antenna, spiral antenna, short dipole antenna, half-wave dipole antenna, broadband dipole antenna, rectangular patch antenna, patch antenna, and folded inverted-F antenna.

24. The wireless communications device of claim 18, wherein the antenna is a planar inverted-F antenna.

25. The wireless communications device of claim 18, wherein the wireless communications device has a plurality of antennas.

26. The wireless communications device of claim 18, wherein the surrounding materials or objects are ground planes, circuits, ground extensions, speakers, microphones, or any component mounted on a printed circuit board.

27. The wireless communications device of claim 18, wherein the reflector is formed on a substrate.

28. The wireless communications device of claim 27, wherein the substrate is selected from the group consisting of flex printed circuit board, rigid printed circuit board, or Kapton printed circuit board.

29. The wireless communications device of claim 18, wherein the reflector is positioned based on the antenna's radiation pattern and where most of the antenna's electromagnetic radiation is directed.

30. The wireless communications device of claim 29, wherein the antenna is optimized to achieve maximum antenna performance after the reflector is positioned.

31. The wireless communications device of claim 18, wherein the reflector is in parallel with the antenna.

32. The wireless communications device of claim 18, wherein the reflector is vertically disposed with respect to the antenna.

33. A method of optimizing antenna performance, comprising the steps of:
positioning a reflector relative to an antenna in a wireless communication device to redirect electromagnetic radiation of the antenna away from surrounding materials or objects that affect or absorb the electromagnetic radiation;
optimizing the distance of the positioned reflector to the antenna to achieve maximum radiation efficiency; and
varying the arm lengths of the antenna based on the antenna frequency band of operation and size constraints of the wireless communication device to achieve maximum antenna performance.
